(19) United States
(12) Patent Application Publication
(10) Pub. No.: US 2017/0171938 A1
(43) Pub. Date: Jun. 15, 2017

(54) ACTIVE LUMINOUS FABRIC

(71) Applicant: Far Eastern New Century Corporation, Taipei (TW)

(72) Inventors: Hsin-Kai Lai, Taoyuan City (TW); Yu-Chun Wu, Taoyuan City (TW); Wei-Che Hung, Taoyuan City (TW)

(21) Appl. No.: 15/256,859

(22) Filed: Sep. 6, 2016

(30) Foreign Application Priority Data
Dec. 10, 2015 (TW) 104141553

(51) Int. Cl. H05B 33/22; A41D 31/00; H05B 33/20; H05B 33/26; H05B 33/14

(52) U.S. Cl. CPC H05B 33/22; H05B 33/26; H05B 33/145; H05B 33/20; A41D 31/00

(57) ABSTRACT

The present invention provides an embedded active luminous fabric. The embedded active luminous fabric includes a base fabric, a pair of conductive parts, a luminous part, and a transparent conductive part. The pair of conductive parts is entirely embedded in the base fabric and disposed apart from each other. The luminous part is disposed on the pair of conductive parts and electrically connects with the pair of conductive parts respectively. The transparent conductive part is disposed on the luminous part. The luminous fabric of present invention improves conventional problems of spot defects generated by luminous fabric illuminating for a long time and provides a thin luminous fabric with more comfortable experience and better feeling of touch for wearers.

### CROSS-REFERENCE TO RELATED APPLICATION

This application claims priority to Taiwanese Application Serial Number 104141553, filed Dec. 10, 2015, which is herein incorporated by reference.

### BACKGROUND

Field of Invention

The present invention relates to an active luminous fabric. More particularly, the present invention relates to a thin active luminous fabric with a long product life cycle.

Description of Related Art

Traditional fabrics provide basic functions of protection, keeping warm and comeliness. Recently, developments of intellectual fabrics were gradually emphasized with the advancement in technology. For satisfying requirements of interactive functions from wearers and increasing added values of the fabrics, more versatile capabilities for the fabrics are pursued.

Previous applications of the intellectual fabrics are mainly based on leisure sports and care to provide safety alerts, illuminating or displaying functions to the wearers. There are many intellectual fabrics with illuminating functions having been consecutively developed nowadays.

The light-emitting mechanism of the luminous fabrics can be categorized into an active type and a passive type. The passive type luminous fabrics utilize reflective materials attached on the fabrics to reflect an incident light to achieve a result similar to illumination. Apparently, the intensity of the reflected light is restricted to the intensity of the incident light source. As the intensity of the incident light source is weaker, the intensity of reflected light also decreases, and thus resulting in hardly achieving purposes of safety alerts.

On the other hand, the active type luminous fabrics achieve light-emitting and displaying goals by disposing many point light sources. Luminous components of the point light sources could be constructed with, for example, light-emitting diodes (LEDs), connected with the fabrics by adherence or sewing. By utilizing light generated by the luminous components, the active type could be used as safety alerts, illumination or displaying. In Japanese patent publication No. 2004-308050, a fabric adhered with multiple LEDs arranged in a predetermined pattern is described. This type only radiates point light at a fixed point, and needs to arrange lots of light-emitting components to display patterns. However, the patterns are not continuous and cannot achieve excellent displaying results. Besides, the displaying light colors are restricted to the light-emitting components themselves, resulting in monotonous and flat ones. Furthermore, due to the combination with the LEDs, this kind of fabric is overly rigid, leading to uncomfortable experience for wearers and bad feeling of touch. Also, the fabric is not suitable for washing.

For solving previous problems, the person of ordinary skill in the art has developed fabrics which adopt the electroluminescence (EL). For instance, U.S. Pat. No. 8,384,288 discloses a kind of electroluminescence fabric which combines known EL components with a fabric. In the technique, a flat layer is firstly printed onto the fabric, for following conductance layers being evenly and homogeneously printed onto the flat layer. Nonetheless, the thickness of the flat layer is above 1 mm (1-60 mm disclosed in the specification of the patent), increasing the total thickness of the luminous fabric. Additionally, it is known that the EL components radiate through conduction between an upper and a lower electrode, which may cause electric shock to users when the users touch the electrodes. As a result, a protective layer should be disposed on this kind of EL components for avoiding the occurrence of leakage current. Besides, in order to achieve conducting state between the upper and lower electrode, it is known that copper foils stuck respectively between the upper, lower electrodes and other components are required. Further, the upper, lower electrodes and other components are welded with wires through the copper foils. The final procedure of manufacturing the fabrics is to connect wires to both ends of a power supply for providing sufficient high voltage to excite the EL components to radiate. Nevertheless, the procedure is disadvantageous to a roll-to-roll (R2R) continuous process. Also, there exist unstable problems at welding points. Furthermore, because the thicknesses of wires cause a thickness difference between the upper, lower electrodes and the other components respectively, the smoothness of the entire luminous fabrics will decrease.

In addition to all the above, burned-out black spot defects are often observed in the light-emitting EL components which radiate by conduction between the upper and lower electrode after long-time light emissions. The black spot defects will influence displaying results, diminish lifetimes of known EL fabrics, and cause poor endurance.

### SUMMARY

Therefore, the object of present invention is to provide an active type luminous fabric to improve deficiencies of known techniques.

In order to accomplish the object, the present invention provides an embedded active luminous fabric which includes a base fabric, a pair of conductive parts, a luminous part and a transparent conductive part disposed on the luminous part. The pair of conductive parts is disposed apart from each other and entirely embedded in the base fabric. The luminous part is disposed on the pair of conductive parts and electrically connects with the pair of conductive parts respectively.

The embedded active luminous fabric of the present invention possesses longer light-emitting lifetimes. Unlike known EL fabrics with burned-out spot defects, the embedded active luminous fabric of the present invention has excellent endurance. Moreover, the embedded active luminous fabric can use alternating currents with different frequencies as power supply to make colors of emission changeable and increase range of applicability.

Besides, the total thickness of the active luminous fabric is thinner than known luminous fabrics, leading to wearing comfort, good feeling of touch, and good smoothness. The fabrics could be manufactured through the R2R continuous process with a low cost and high productivity, which increases the yield.

### BRIEF DESCRIPTION OF THE DRAWINGS

The invention can be more fully understood by reading the following detailed description of the embodiment, with reference made to the accompanying drawings as follows:

FIG. 1 is a cross-sectional schematic view of an embedded active luminous fabric according to first embodiment of the present invention;

FIG. 2 is a cross-sectional schematic view of a pair of conductive parts connecting with printed wires according to one embodiment of the present invention;

FIG. 3 shows a cross-sectional schematic view of a luminous part partially embedded in a base fabric in the present invention;

FIG. 4 shows a cross-sectional schematic view of a luminous part entirely embedded in a base fabric in the present invention;

FIG. 5 shows a cross-sectional schematic view of a transparent conductive part entirely embedded in a base fabric in the present invention;

FIG. 6 is a cross-sectional schematic view of an embedded active luminous fabric according to second embodiment of the present invention;

FIG. 7 shows a cross-sectional schematic view of a dielectric part which is disposed as a type of continuous layer in the present invention;

FIG. 8 is a cross-sectional schematic view of another disposition of a dielectric part in the present invention;

FIG. 9 is a cross-sectional schematic view of an embedded active luminous fabric according to third embodiment of the present invention;

FIG. 10 is a three-dimensional view of one embodiment with a top fabric in the present invention;

FIG. 11 is a three-dimensional view of another embodiment with a top fabric in the present invention;

FIG. 12 is a three-dimensional view of the other embodiment with a top fabric in the present invention; and

FIG. 13 shows a cross-sectional schematic view of one embodiment with a substantially discontinuous base fabric in the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following embodiments are disclosed with accompanying diagrams for detailed description. For illustration clarity, many details of practice are explained in the following descriptions. However, it should be understood that these details of practice do not intend to limit the present invention.

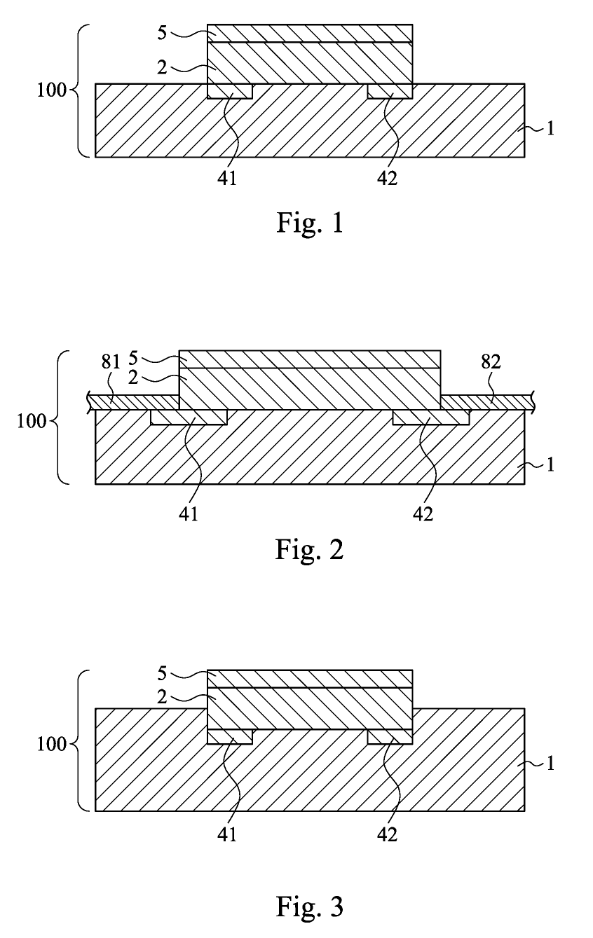

Please refer to FIG. 1 which is a cross-sectional schematic view of an embedded active luminous fabric 100 according to first embodiment of the present invention. The embedded active luminous fabric 100 contains a base fabric 1, a pair of conductive parts, 41 and 42, which is entirely embedded in the base fabric 1, a luminous part 2, which is disposed on and electrically connected with the pair of conductive parts, 41 and 42, and a transparent conductive part 5, which is disposed on the luminous part 2.

Please refer to FIG. 2. The pair of previously described conductive parts, 41 and 42, is substantially disposed apart from each other and is in contact with wires 81 and 82 respectively. The wires, 81 and 82, connect a positive electrode and a negative electrode of a power supply respectively to form a conductive loop. Besides, the power supply provides an enough voltage to make the luminous part 2, which is electrically connected to the pair of conductive parts, 41 and 42, radiate.

The previously described power supply, which is connected with the wires, 81 and 82, can provide direct current with a single frequency or alternating current with a variable frequency. The direct current with a single frequency can make the luminous part 2, which is electrically connected with the pair of conductive parts, 41 and 42, emit monochromatic light with the specific frequency. On the other hand, the alternating current with a variable frequency can make the luminous part 2 vary its color of light with different frequencies, leading to an effect of multicolor display.

The pair of conductive parts, 41 and 42, which is substantially disposed apart from each other, can be disposed according to different requirements. For instance, in order to achieve convenience of fabrication or structural design requirements, the pair of conductive parts, 41 and 42, can be arranged in a predetermined pattern.

Furthermore, the disposition of the pair of conductive parts, 41 and 42, is not limited to areas where the luminous part 2 covers. Namely, some portions of the pair of conductive parts, 41 and 42, are not in contact with the luminous part 2 (see FIG. 2). The wires, 81 and 82 can be directly printed onto or adhered on the portions of the pair of conductive parts, 41 and 42, which are not in contact with the luminous part 2. The adherence is performed by using anisotropic conductive adhesive to make the R2R continuous process proceed successfully and retain the smoothness of the fabric.

There is no special limitation on fabrication methods of the embedded active luminous fabric 100 in the present invention. For example, the transparent conductive part 5 is firstly disposed on a release film, which can be easily torn, and then the luminous part 2 is disposed on the transparent conductive part 5. Subsequently, the pair of conductive parts, 41 and 42, is disposed on the luminous part 2, and the wires, 81 and 82, are eventually printed onto the pair of conductive parts, 41 and 42. Next, a base fabric 1 is adhered to the release film on which the pair of conductive parts, 41 and 42, is disposed. By utilizing a heated roller which presses on the fabric, the pair of conductive parts, 41 and 42, is entirely embedded into the base fabric 1 and then the release film is torn. The embedded active type luminous fabric 100 is obtained.

On the other hand, the fabrication of the previously described embedded active luminous fabric 100 can also proceed as the following steps. The pair of conductive parts, 41 and 42, is directly disposed on the base fabric 1, and then the luminous part 2 is disposed on the pair of conductive parts, 41 and 42. Subsequently, the transparent conductive part 5 is disposed on the luminous part 2. After that, by utilizing a heated roller which presses on the transparent conductive part 5, the pair of conductive parts, 41 and 42, is entirely embedded into the base fabric 1. Eventually, the wires, 81 and 82, are printed onto the portions of the pair of conductive parts, 41 and 42 which are not in contact with the luminous part 2 (see FIG. 2).

The previous way of disposing the wires, 81 and 82, can be performed by printing methods including but not limited to screen printing, intaglio and nano-imprint.

Besides, conductive yarn, which is utilized as the wires, 81 and 82, can be seamed on the portions of the base fabric 1 corresponding to the pair of conductive parts, 41 and 42 in advance.

The pair of conductive parts, 41 and 42, described in the present invention includes conductive emulsion and binders for dispersion. The luminous part 2, which is electrically connected with the pair of conductive parts, 41 and 42, can radiate when the pair of conductive parts, 41 and 42, has lower resistance. Accordingly, the conductive emulsion with lower resistance is often adopted.

There is no specific limitation to the conductive emulsion in the present invention. The conductive emulsion includes but not limited to gold paste, silver paste, aluminum paste, or copper paste.

There is no specific limitation to the previously described way of disposing the pair of conductive parts, 41 and 42. The pair of conductive parts, 41 and 42, is arranged in a predetermined pattern by printing methods including but not limited to intaglio, screen printing, letterpress, or slit coating method.

The thicknesses of the pair of previously described conductive parts, 41 and 42, are 5-15 μm respectively.

The luminous part 2 includes light-emitting powder and binders for dispersion.

There is no specific limitation to the light-emitting powder used in the present invention within the luminous part 2. As long as the powder can display different colors for different frequencies provided by the power supply, it can be used here. The light-emitting powder can be chosen from the group consisting of zinc sulfide, zinc selenide, strontium sulfide and calcium sulfide.

There is no specific limitation to the way of disposing the luminous part 2 described above. In order to achieve convenience of operations and continuity of processes, the luminous part 2 may be disposed by the methods including but not limited to intaglio, screen printing, letterpress and slit coating method.

The thickness of the previously described luminous part 2 is 5-15 μm.

The weight percent of the light-emitting powder in the luminous part 2 can be adjusted according to required luminous intensity in the present invention. Preferably, the weight percent is 70-90 wt %.

In order to make the luminous part 2 have high enough luminous and displaying intensity, the transparent conductive part 5, which is disposed on the luminous part 2, must have high enough transmittance. Therefore, the thickness of the transparent conductive part 5 cannot be too large. Preferably, the thickness is 10-300 nm. Most preferably, the thickness is 20-250 nm. Furthermore, the haze value of the transparent conductive part 5 cannot be too large and should be within a range of 0.1-40 for avoiding a decrease in transmittance, because the light emitted from the luminous part 2 may be scattered by material particles within the transparent conductive part 5.

The transparent conductive part 5 in the present invention is composed of metal or nonmetal materials. The metal materials include but not limited to nanoparticles of gold, silver and copper, metal oxides such as indium tin oxide, antimony tin oxide and indium zinc oxide, or a combination thereof. The nonmetal materials include but not limited to, carbon nanotube, carbon black, carbon fiber, graphene, conductive polymers such as poly(3,4-ethylenedioxythiophene) (PEDOT), polyacrylonitrile (PAN) or a combination thereof.

There is no specific limitation to the way of disposing the transparent conductive part 5. According to categories of materials and convenience of operating fabricating machine, the transparent conductive part 5 may be disposed by wet coating method such as intaglio, screen printing, letterpress and slit coating method, or dry plating method such as sputtering.

Please refer to FIG. 1 to FIG. 5. The previously described heated roller is used to embed the pair of conductive parts, 41 and 42, entirely into the base fabric 1. With different settings of pressures, different embedded degrees of the embedded active luminous fabrics 100 could be obtained. For instance, the luminous part 2 and the transparent conductive part 5 can be partially embedded into the base fabric 1 with different degrees respectively, or both the luminous part 2 and the transparent conductive part 5 can be entirely embedded into the base fabric 1.

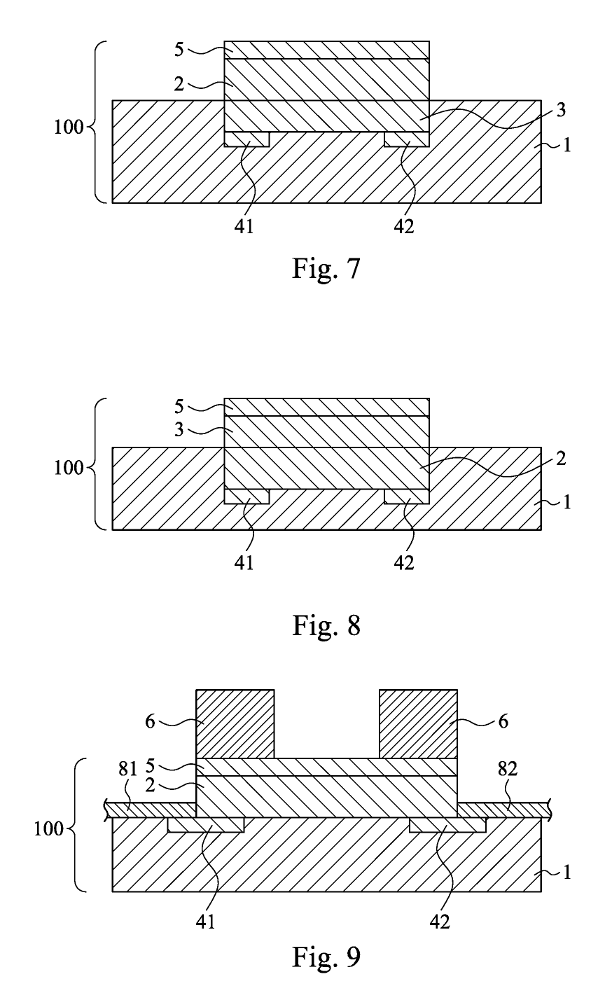

Please refer to FIG. 6 to FIG. 7, which are cross-sectional schematic views of an embedded active luminous fabric 100 according to second embodiment of the present invention. A dielectric part 3 is further included on the pair of previously described conductive parts, 41 and 42, and lies between the pair of conductive parts, 41 and 42, and the luminous part 2.

The previously described dielectric part 3 is substantially continuously disposed or substantially discontinuously disposed. For example, the dielectric part 3 can be arranged in a predetermined pattern as the pair of conductive parts, 41 and 42, which is separated and disposed opposite each other (see FIG. 6). The dielectric part 3 also can be disposed on the pair of conductive parts, 41 and 42, in a form of continuous layer (see FIG. 7). The dielectric part 3 can be directly disposed on the pair of conductive parts, 41 and 42, or disposed on the release film, and then transferred onto the pair of conductive parts, 41 and 42.

There is no specific limitation to previously described way of disposing the dielectric part 3. In order to achieve convenience of operations and continuity of processes, the dielectric part 3 may be disposed by methods including but not limited to intaglio, screen printing, letterpress and slit coating method.

There is no specific limitation to the thickness of the dielectric part 3, which is on the pair of conductive parts, 41 and 42. Preferably, the thickness of the dielectric part 3 is 5-15 μm.

Please refer to FIG. 8, a dielectric part 3 is further included on the luminous part 2. The dielectric part 3 is between the luminous part 2 and the transparent conductive part 5.

The previously described dielectric part 3 is substantially continuously disposed or substantially discontinuously disposed. For example, the dielectric part 3 can be arranged in a predetermined pattern, separated from each other, and disposed opposite each other. The dielectric part 3 also can be disposed on the luminous part 2 in a form of continuous layer. The dielectric part 3 can be directly disposed on the luminous part 2, or disposed on the release film, and then transferred onto the luminous part 2.

There is no specific limitation to previously described way of disposing the dielectric part 3. In order to achieve convenience of operations and continuity of processes, the dielectric part 3 may be disposed by methods including but not limited to intaglio, screen printing, letterpress and slit coating method.

The dielectric part 3 disposed on the pair of conductive parts, 41 and 42, or on the luminous part 2 of the present invention is utilized to lower a required driven voltage. Its material properties make it have compact holes for preventing penetration of water vapor and provide excellent adhesion between the upper and lower parts. These advantages make the embedded active luminous fabric 100 provide better performance.

In the present invention, the dielectric part 3 on the pair of conductive parts, 41 and 42, or on the luminous part 2 is composed of dielectric materials and binders for dispersion.

There is no specific limitation to the dielectric materials of the present invention. Better options are those materials with high dielectric constants (dielectric constant larger than 7). The dielectric material can be selected from the group consisting of aluminium oxide, barium carbonate and barium titanate.

In order to make the luminous part 2 have high enough luminous and displaying intensity, the previously described dielectric part 3 on the luminous part 2 must has high enough transmittance (see FIG. 8). Therefore, the whole thickness of the dielectric part 3 cannot be too large for avoiding bad influence on transmittance and displaying of the luminous part 2. Preferably, the thickness is 20-400 nm. Most preferably, the thickness is 100-300 nm. Moreover, the haze value of the dielectric part 3 cannot be too large and is within a range of 10-50 for avoiding a decrease in transmittance, because the light emitted from the luminous part 2 may be scattered by dielectric materials within the dielectric part 3. Therefore, the haze value can be controlled by adjusting the weight percent of the dielectric materials in the dielectric part 3. Preferably, the range of weight percent of the dielectric materials in the dielectric part 3 is 5-30 wt %. Most preferably, the range is 10-20 wt %.

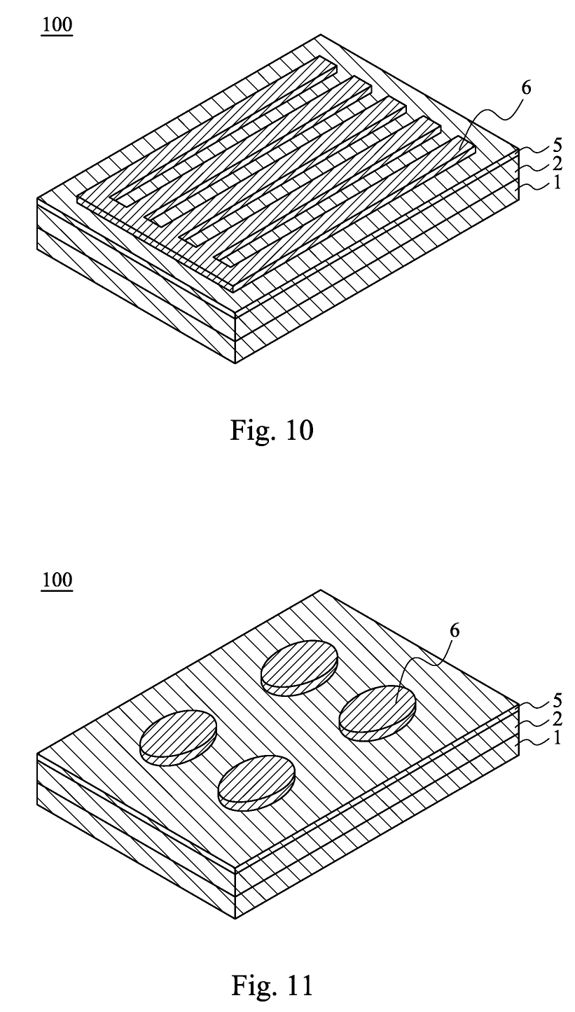

Please refer to FIGS. 9-12. A light-blocking part 6 is further included on the transparent conductive part 5. The light-blocking part 6 can be disposed substantially continuously or discontinuously. For instance, according to aesthetic design or requirements of fabrication, the light-blocking part 6 can be arranged in a predetermined pattern. The predetermined patterns may be substantially continuously comb-like (as shown in FIG. 10, the pair of conductive parts, 41 and 42, is not shown since it is entirely embedded into the base fabric 1) or arbitrary font shape. The predetermined patterns can also be substantially continuous geometries with some intervals among them or substantially discontinuous geometries separated with each other (as shown in FIG. 11). There is no specific limitation to the predetermined pattern. All patterns satisfying requirements of luminous patterns or luminous effects can be used here. The luminous part 2 can radiate and display a predetermined luminous pattern from the regions uncovered by the light-blocking part 6.

In one embodiment, the light-blocking part 6 that can be used in the present invention is a polymer resin layer.

There is no limitation to the polymer resin contained in the previously described polymer resin layer. The polymer resin may be chosen from the group consisting of polyurethane resin and polyepoxide resin. Preferably, the polymer resin is polyurethane resin and can provide cozier feeling of touch and more comfortable experience for wearers.

There is no specific limitation to the previously described way of disposing the polymer resin layer. According to convenience of operation, the polymer resin layer is disposed by methods including but not limited to intaglio, screen printing, letterpress, slit coating method, or transfer printing and adherence.

In another embodiment, the light-blocking part 6 that can be used in the present invention is a top fabric.

According to aesthetic designs or requirements of fabrication, a top fabric can be tailored along with a predetermined pattern. The predetermined pattern can be substantially continuous comb-like or arbitrary font shape. The predetermined patterns can also be substantially continuous geometries with some intervals among them or substantially discontinuous geometries separated with each other. Different top fabrics with different fabric materials can be combined. There is no specific limitation to the predetermined patterns. All patterns satisfying requirements of luminous patterns or luminous effects can be used here. The top fabric is then disposed on the transparent conductive part 5. There is no specific limitation to the disposing methods, which can be determined according to convenience of operations. The disposing method includes but not limited to adherence or tailoring.

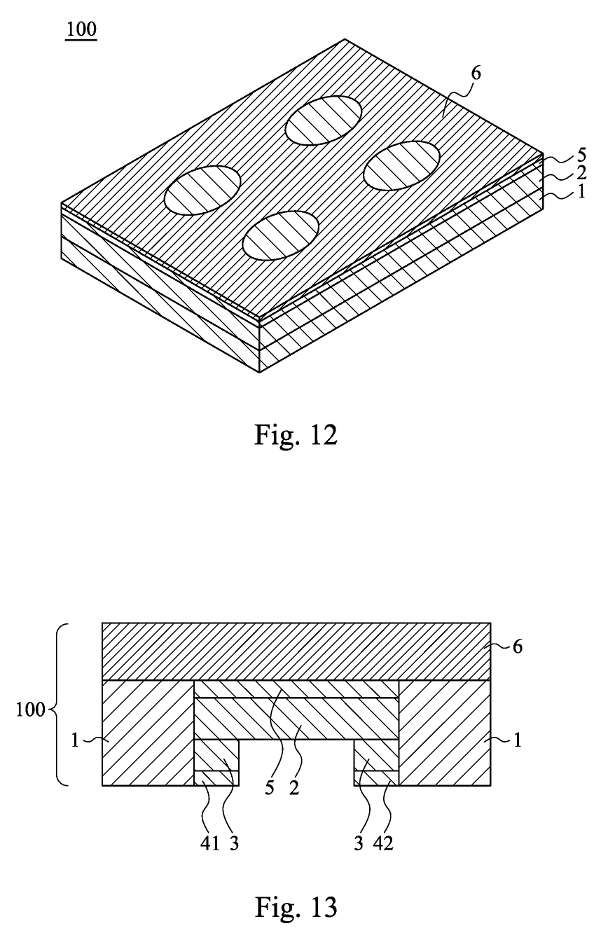

Moreover, the top fabric and the base fabric 1 are not restricted to be the same size. The determination of the size depends on requirements such as its applicability, its aesthetic design and so on. Therefore, the top fabric can partially cover the base fabric 1 with continuously predetermined patterns (as shown in FIG. 12), or it can be larger than the base fabric 1.

There is no specific limitation to the top fabric in the present invention. According to requirements of functionalities or aesthetic designs, the top fabric can be selected from woven fabric or knitted fabric, but is not limited to these fabrics.

Preferably, the light-blocking part 6 in the present invention is partially transparent or completely opaque.

There is no specific limitation to the base fabric 1 in the present invention. According to requirements of functionalities or aesthetic designs, the top fabric can be selected from woven fabric or knitted fabric, but is not limited to these fabrics.

The base fabric 1 in the present invention can be substantially discontinuous. For example, two or more separated base fabrics 1 can be used (see FIG. 13). The pair of conductive parts, 41 and 42, the dielectric part 3, the luminous part 2 and the transparent conductive part 5 are all entirely embedded in the base fabric 1. Those parts and the base fabric 1 are connected by the light-blocking part 6. Moreover, the separated base fabrics 1 may be different fabrics (woven fabric or knitted fabric) or different colors and patterns. Since there is no specific limitation, the base fabric 1 can be adjusted according to aesthetic designs or wearing comfort.

There is no specific limitation to the binders, which are utilized to the pair of conductive parts, 41 and 42, the luminous part 2 and the dielectric part 3 for dispersion. The binder includes but not limited to polyurethane resin, peroxide resin, polymethylmethacrylate, silicone resin, castor oil or a combination thereof.

The following lists several embodiments of the present invention in a more elaborate way, then it is only an example for illustrative purposes and are not intended to limit the present invention, the scope of the present invention is defined by the claims and their equivalents are defined.

Chemicals and Instruments

1. Polyurethane is taken from YamaKen and the product number is CD-5030 (solid content: 30 wt/%, solvent: n-Butyl acetate (nBAC)).

2. Release film is release film with 50 um taken from Mitsubishi.

3. Poly(3,4-ethylenedioxythiophene):polystyrene sulfonate (PEDOT:PSS) dispersion is taken from AGFA-Gevaert and the product number is ICP1010 (solid content: 1 wt/c/o, solvent: water).

4. Light-emitting powder is taken from Advanced Electronic Materials Inc (ITK) and the product number is GG64.

5. Dielectric material is taken from Advanced Electronic Materials Inc and the product number is BT-4M, which is barium carbonate powder.

6. Conductive silver paste is taken from Advanced Electronic Materials Inc and the product number is GA-6401.

7. Screen is taken from Chi Long Technology and the product number is Tetoron.

8. Luminance colorimeter is taken from Topcon and the product number is BM-7A.

9. Blue light storing fiber is taken from SHUAN JIUH Enterprise Co., Ltd and the product number is Lumi Long.

### Embodiment 1

Fabrication of an embedded active luminous fabric includes the following steps:

(1.1) 5 g polyurethane resin is measured and mixed with 45 g conductive silver paste homogeneously. The mixture is printed onto a base fabric in a predetermined pattern by utilizing a screen with 200 meshes. After the printed mixture is dehydrated with hot wind at a temperature of 150° C. for 3 minutes, a pair of conductive parts disposed apart from each other is formed with a thickness of about 10 μm.

(1.2) 20 g polyurethane resin is measured and mixed with 40 g light-emitting powder to obtain a light-emitting coating solution. The light-emitting coating solution is printed onto the pair of conductive parts formed in the step (1.1) by utilizing a screen with 200 meshes. After the printed light-emitting coating solution is dehydrated with hot wind at a temperature of 150° C. for 3 minutes, a luminous part is formed with a thickness of about 10 μm.

(1.3) 10 g PEDOT:PSS dispersion is measured and printed onto the luminous part formed in the step (1.2) by utilizing a screen with 100 meshes through intaglio. After solvents are vaporized with hot wind at a temperature of 150° C. for 3 minutes, a transparent conductive part is formed with a thickness of about 200 nm.

(1.4) 50 g polyurethane resin is measured and printed onto the transparent conductive part formed in the step (1.3) according to a predetermined comb-like pattern by utilizing a screen with 200 meshes through screen printing. After solvents are vaporized with hot wind at a temperature of 150° C. for 3 minutes, a light-blocking part is formed with a thickness of about 20 μm.

(1.5) The light-blocking part formed in the step (1.4) is pressed by utilizing a heated roller with pressure 4 kg and 200° C. to obtain an embedded active luminous fabric (the pair of conductive parts is entirely embedded into the base fabric as shown in FIG. 9) with a total thickness of 530.2 μm (thickness of the base fabric is 500 μm).

(1.6) The embedded active luminous fabric formed in the step (1.5) is obtained. A wire connecting with positive electrode and negative electrode of a power supply is printed onto portions of the pair of conductive parts which is not in contact with the luminous part. The luminous part is driven by voltage to radiate and then tested by a luminance colorimeter to take a luminance test. The test results are shown in the table 1.

### Embodiment 2

Fabrication of an embedded active luminous fabric includes the following steps:

(2.1) 10 g PEDOT:PSS dispersion is measured and printed onto a release film by utilizing a screen with 100 meshes through intaglio. After solvents are vaporized with hot wind at a temperature of 150° C. for 3 minutes, a transparent conductive part is formed with a thickness of about 200 nm.

(2.2) 20 g polyurethane resin is measured and mixed with 40 g light-emitting powder to obtain a light-emitting coating solution. The light-emitting coating solution is printed onto the transparent conductive part formed in the step (2.1) by utilizing a screen with 200 meshes through screen printing. After the printed light-emitting coating solution is dehydrated with hot wind at a temperature of 150° C. for 3 minutes, a luminous part is formed with a thickness of about 10 μm.

(2.3) 5 g polyurethane resin is measured and mixed with 45 g conductive silver paste homogeneously. The mixture is printed onto the luminous part formed in the step (2.2) according to a predetermined pattern by utilizing a screen with 200 meshes. After the printed mixture is dehydrated with hot wind at a temperature of 150° C. for 3 minutes, a pair of conductive parts is formed with a thickness of about 10 μm.

(2.4) A portion of the base fabric corresponding to the pair of conductive parts is sewed, in advance, with conductive yarns used as wires. The pair of conductive parts formed in the step (2.3) is adhered to the base fabric to ensure that the wires are electrically connected with the pair of conductive parts. A heated roller is further pressed onto the fabric with 200° C. and pressure 5 kg. Then the release film is torn to obtain an embedded active luminous fabric. The pair of conductive parts is entirely embedded into the base fabric as shown in FIG. 1. The total thickness of the embedded active luminous fabric is about 510.2 μm, wherein the thickness of the base fabric is 500 μm.

(2.5) The wires are connected to the positive and negative electrodes of the power supply respectively. The luminous part is driven by voltage to radiate and then tested by a luminance colorimeter to take a luminance test. The test results are shown in the table 1.

### Embodiment 3

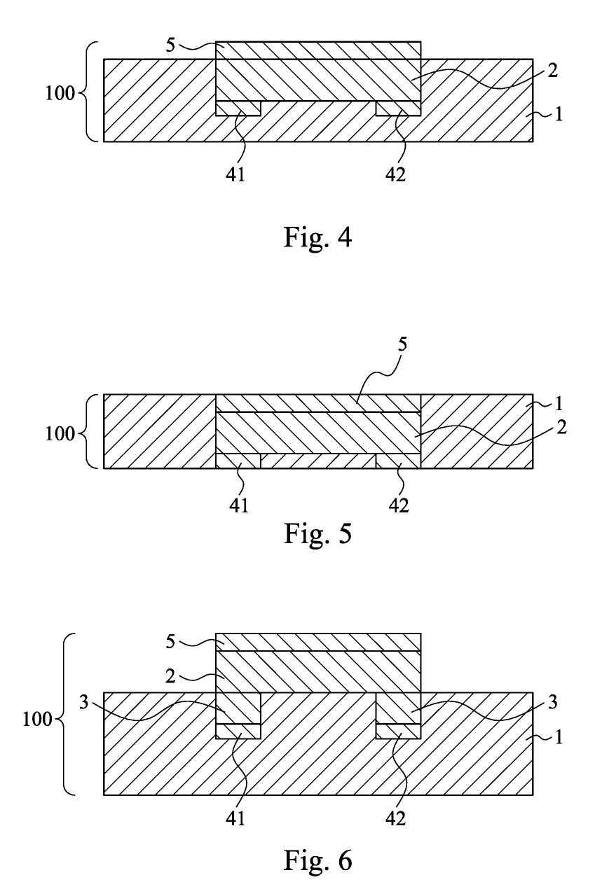

The fabrication of embodiment 3 is similar to the embodiment 2. The difference between the embodiments 2 and 3 is that the heated roller of the embodiment 3 in step (2.4) is pressed onto the fabric with pressure 8 kg. An embedded active luminous fabric with a total thickness of 500.2 μm is obtained, wherein the thickness of the base fabric is 500 μm. The luminous part and the pair of conductive parts are entirely embedded into the base fabric as shown in FIG. 4.

### Embodiment 4

The fabrication of embodiment 4 is similar to the embodiment 2. The difference between the embodiments 2 and 4 is that the heated roller of the embodiment 4 in step (2.4) is pressed onto the fabric with pressure 6.5 kg. An embedded active luminous fabric with a total thickness of 505.2 μm is obtained, wherein the thickness of the base fabric is 500 μm. The pair of conductive parts is entirely embedded into the base fabric and the luminous part is partially embedded in the base fabric as shown in FIG. 3.

### Comparative Example 1

Fabrication of an known luminous fabric (please refer to U.S. Pat. No. 8,384,288) includes the following steps:

(1.1) 100 g polyurethane resin is measured and printed onto a base fabric by utilizing a screen with 50 meshes through screen printing. After solvents are vaporized with hot wind at a temperature of 150° C. for 3 minutes, a printing layer is formed with a thickness of about 1 mm.

(1.2) A copper foil with an area of 2 cm×2 cm and a thickness of 70 μm is smoothly disposed on the printing layer, and then a first wire is welded on the copper foil with solder.

(1.3) 5 g polyurethane is measured and mixed with 45 g conductive silver paste homogeneously. The mixture is printed onto the printing layer having the first wire by utilizing a screen with a 200 meshes through screen printing. After the printed mixture is dehydrated with hot wind at a temperature of 150° C. for 3 minutes, a conductive layer is formed with a thickness about 10 μm.

(1.4) 20 g polyurethane resin is measured and mixed with 40 g dielectric material homogeneously. The mixture is printed onto the conductive layer formed in the step (1.3) by utilizing a screen with 200 meshes through screen printing. After the printed mixture is dehydrated with hot wind at a temperature of 150° C. for 3 minutes, a dielectric layer is formed with a thickness of about 10 μm.

(1.5) 20 g polyurethane resin is measured and mixed with 40 g light-emitting powder homogeneously to obtain a light-emitting coating solution. The light-emitting coating solution is printed onto the dielectric layer formed in step (1.4) by utilizing a screen with 200 meshes through screen printing. The printed light-emitting coating solution is dehydrated with hot wind at a temperature of 150° C. for 3 minutes to remove solvents. Eventually, a luminous layer with a thickness of about 10 μm is formed.

(1.6) 10 g PEDOT:PSS dispersion is measured and printed onto the luminous layer formed in the step (1.5) by utilizing a screen with 100 meshes through intaglio. After the printed dispersion is dehydrated with hot wind at a temperature of 150° C. for 3 minutes, a transparent conductive layer with a thickness of about 200 nm is formed.

(1.7) A copper foil with an area of 2 cm×2 cm and a thickness of about 70 μm is smoothly disposed on the transparent conductive layer, and a second wire is welded on the copper foil with solder.

(1.8) 50 g polyurethane resin is measured and printed onto the transparent conductive layer having the second wire by utilizing a screen with 200 meshes through screen printing. After solvents are vaporized with hot wind at a temperature of 150° C. for 3 minutes, an insulating protective layer with a thickness of about 20 μm is formed. A known luminous fabric with a total thickness of 1690.2 μm and a bad smoothness is obtained, wherein the thickness of the base fabric is 500 μm.

(1.9) The first wire and the second wire are connected to the positive and negative electrodes of the power supply respectively. The light-emitting layer is driven by voltage to radiate and then tested by a luminance colorimeter to take a luminance test. The test results are shown in the table 1.

### Comparative Example 2

Fabrication of light-storing and luminous fabrics includes the following steps:

(2.1) According to operating conditions of the standard ASTM D1907-89, the blue light-storing fabric (about 10 g) is rolled up and cut with a length of 90 m by utilizing a yarn winder.

(2.2) The environmental temperature is set to 25° C. and the humidity is set to 65%. D65 light source with an illuminance of 1100 Lux is used for storing light. After the blue light-storing fabric is illuminated by the light source for 10 minutes, the fabric is then disposed in an entirely dark environment. Subsequently, the luminance of the fabric is detected by a luminance colorimeter to take a luminance test and the test results are shown in the table 1.

Endurance Test

The luminance of the luminous fabrics fabricated in the embodiments 1-4 and the comparative example 1-2 are tested by utilizing a luminance colorimeter. The fabrics are disposed in an environment with a temperature of 25° C. and a humidity of 65%. A comparison of luminance tested at different times, 6 hrs, 10000 hrs and 12000 hrs, are shown in the table 1. The unit used for the above luminance tested by the luminance colorimeter is nit, which is equal to cd/m². Furthermore, the rate of luminance endurance is calculated from the ratio of the luminance tested after 12000 hrs to the luminance tested at the first time.

TABLE 1

| | | | | | Rate of |
|---|---|---|---|---|---|
| | First | | Luminance | Luminance | luminance |
| | luminance | Luminance | test after | test after | endurance |
| | test | test after 6 hrs | 10000 hrs | 12000 hrs | after 12000 hrs |
| Embodiment 1 | 150 nits | 150 nits | 130 nits | 110 nits | 73.33% |
| Embodiment 2 | 150 nits | 150 nits | 132 nits | 113 nits | 75.33% |
| Embodiment 3 | 150 nits | 148 nits | 109 nits | 98 nits | 65.33% |
| Embodiment 4 | 150 nits | 150 nits | 121 nits | 105 nits | 70% |
| Comparative | 150 nits | 150 nits | 71 nits | 59 nits | 39.33% |
| Example 1 | | | | | |
| Comparative | 0.3 nits | 0.0032 nits | <0.0032 nits | <0.0032 nits | 1.07% |
| Example 2 | | | | | |

From the table 1, it can be seen that except for the light-storing fabric in the comparative example 2, the luminance of the first test for fabrics in embodiments 1-4 and comparative example 1 are set to 150 nits and decreases unobviously after passing 6 hrs, such that it can be known that the luminous fabrics all have excellent performances of luminance within 6 hrs. After passing 10000 hrs, the luminance in the embodiments 1-4 still retain over 100 nits; however, the luminance in the comparative embodiment 1 reduces to 71 nits, and namely the reduction of the luminance sharply exceeds 50%. Besides, when the light-emitting surface of the luminous fabric in the comparative embodiment 1 is observed, some spot defects (dark spots on the light-emitting surface which cannot radiate normally) visible to the naked eye emerge. Since the structure of the known fabric in the comparative embodiment 1 radiates by conduction between the upper and lower electrodes, current flowing through the luminous layer is larger. As a result, after the known fabric radiates for a long time, there will occur burned-out portions in the luminous layer in which spot defects emerge, such that displaying results would be further influenced.

After passing 12000 hrs, the luminance in the comparative embodiment 1 reduces to 59 nits and the rate of luminance endurance is lower than 40%. After passing 12000 hrs, the luminance in the embodiments 1-4 retain at least 98 nits and the rates of luminance endurance are all above 65%. The rates of luminance endurance of embodiments 1 and 2 are even higher than 73%. Namely, the endurances are excellent. It can be known that the luminous fabric in the disclosure of the present invention can increase lifetimes and provide fabulous displaying results.

Please refer to the embedded active luminous fabrics in the embodiment 1 to embodiment 4. The total thicknesses are about 500.2-530.2 μm which includes the thickness of the base fabric, 500 μm. That is, all parts contained in the luminous fabrics only increase about 6% thickness of the base fabric. Therefore, the luminous fabrics can provide excellently comfortable experience for wearers and cozy feelings of touch. Oppositely, the thickness of the known luminous fabric in the comparative example 1 reaches as high as 1690.2 μm which includes the thickness of the base fabric, 500 μm. All parts contained in the luminous fabric increase more than 200% thickness of the base fabric. Hence, both feeling of touch and softness of the fabric are not good, which leads to uncomfortable experience for wearers.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An embedded active luminous fabric, comprising:
a base fabric;
a pair of conductive parts entirely embedded in the base fabric;
a luminous part disposed on the pair of conductive parts and electrically connecting with the pair of conductive parts respectively; and
a transparent conductive part disposed on the luminous part, wherein the pair of conductive parts is disposed apart from each other.

2. The embedded active luminous fabric of claim 1, further comprising a dielectric part on the pair of conductive parts and between the pair of conductive parts and the luminous part.

3. The embedded active luminous fabric of claim 1, further comprising a dielectric part on the luminous part and between the luminous part and the transparent conductive part.

4. The embedded active luminous fabric of claim 2, wherein the dielectric part is continuously disposed or discontinuously disposed.

5. The embedded active luminous fabric of claim 3, wherein the dielectric part is continuously disposed or discontinuously disposed.

6. The embedded active luminous fabric of claim 1, wherein the luminous part is entirely embedded in the base fabric.

7. The embedded active luminous fabric of claim 1, wherein the luminous part is partially embedded in the base fabric.

8. The embedded active luminous fabric of claim 6, wherein the transparent conductive part is entirely embedded in the base fabric.

9. The embedded active luminous fabric of claim 6, wherein the transparent conductive part is partially embedded in the base fabric.

10. The embedded active luminous fabric of claim 1, further comprising a light-blocking part on the transparent conductive part.

11. The embedded active luminous fabric of claim 10, wherein the light-blocking part is continuously disposed or discontinuously disposed.

12. The embedded active luminous fabric of claim 1, wherein the light-blocking part is a polymer resin layer or a top fabric.

13. The embedded active luminous fabric of claim 12, wherein the light-blocking part is a top fabric and the top fabric continuously but does not entirely cover the base fabric.

14. The embedded active luminous fabric of claim 1, wherein the base fabric is discontinuously disposed.
